(19) United States
(12) Patent Application Publication
(10) Pub. No.: US 2012/0141691 A1
(43) Pub. Date: Jun. 7, 2012

(54) METHOD OF APPLYING A METALLIC PRECURSOR TO A TITANIUM OXIDE COATING TO FORM A COMPOSITE COATING OR MATERIAL

(76) Inventors: Chun-Ting LIN, Hsinchu City (TW); Hung Ji Huang, Hsinchu City (TW); Jr-Jung Yang, Hsinchu City (TW); Ming-Hua Shiao, Hsinchu City (TW)

(21) Appl. No.: 12/957,914

(22) Filed: Dec. 1, 2010

(51) Int. Cl. B05D 3/06

(52) U.S. Cl. 427/558

(57) ABSTRACT

The method of the present invention comprises the following three steps: (1) Coating titanium oxide in the form of a membrane, nanometer-sized particles or powder onto a substrate to form a preliminary coating; (2) Adding a reducing agent and a dispersing agent to a metallic precursor to form a solution and then using an application device to apply a small amount of the solution to the preliminary coating; and (3) Using ultraviolet radiation on the substrate to reduce the metallic precursor to a metal via photochemical reaction and hence to form a composite coating. The method is simple and may be used for substrates in different sizes. In addition, in the method, the solution may be evenly spread out on the preliminary coating. The final composite coating may be used as the electrodes of a proton exchange membrane fuel cell.

### BACKGROUND OF THE INVENTION

1. Field of the Invention

The invention generally relates to a method of applying a metallic precursor on a titanium oxide coating. More particularly, the invention relates to a method of applying a metallic precursor on a titanium oxide coating to form a composite coating or structure.

2. Description of the Prior Art

The catalyst coating that may be evenly spread out in large areas and may be produced in high precision repeatedly has been a goal in the development and improvement of fuel cells. S. Towne and A. D. Taylor published two articles in the Journal of Power Sources about the manufacturing method by the use of ink printing to attain the result of catalyst application in an evenly spread-out and high-precision quantitative control manner for large areas. In the prior art, a composite ink containing metal and carbon is applied to the surface to be used as the catalyst for the fuel cell. Such method requires a precise control of the consistency and homogeneity in the viscosity level of the ink. Because nanometer-sized particles may stick together, this may affect the consistency in the ink's viscosity level and thus affect the accuracy of the printing. Moreover, this may clog up the nozzle.

From the above, we can see that the method of the prior art has many disadvantages and needs to be improved.

### SUMMARY OF THE INVENTION

In the method of the present invention, titanium oxide in the form of membrane, nanometer-sized particles or powder is coated onto a substrate to form a preliminary titanium oxide coating. Then, a solution is formed containing a metallic precursor which is then apply in a small amount to the preliminary titanium oxide coating. Next, ultraviolet radiation is used on the substrate to reduce the metallic precursor to a metal (because titanium oxide can decompose the metallic precursor after the former is radiated with ultraviolet radiation). A membrane or spread-out clusters are formed on the preliminary titanium oxide coating.

The method of applying a metallic precursor to a titanium oxide coating to form a composite coating is disclosed. The method of the present invention comprises the following three steps:
(1) Coating titanium oxide in the form of membrane, nanometer-sized particles or powder to a substrate to form a preliminary coating.
(2) Adding a reducing agent and a dispersing agent to a metallic precursor to form a solution and then applying a small amount of the solution to the preliminary coating.
(3) Using ultraviolet radiation on the substrate to reduce or decompose the metallic precursor to a metal and hence to form a composite coating.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view schematically illustrating how the application is done in the prior art;

FIG. 2 is a view schematically illustrating the three steps of the method of the present invention;

FIG. 3 is a view schematically illustrating that the metal is in the form of particles and these particles form small clusters scattered on top of the preliminary titanium oxide coating in the present invention; and

FIG. 4 is a view schematically illustrating that the metal is in the form of a membrane formed on top of the preliminary titanium oxide coating in the present invention.

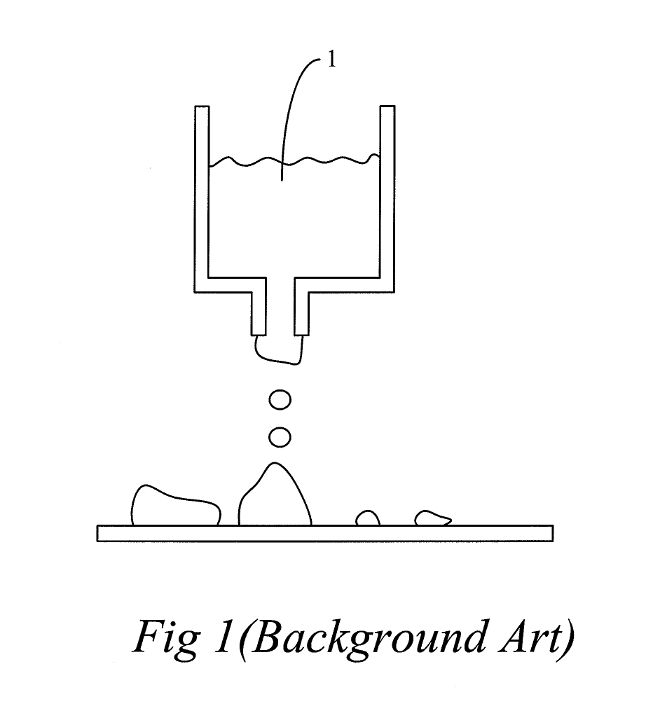

### DETAILED DESCRIPTION OF THE PREFERRED EMBODIMENT

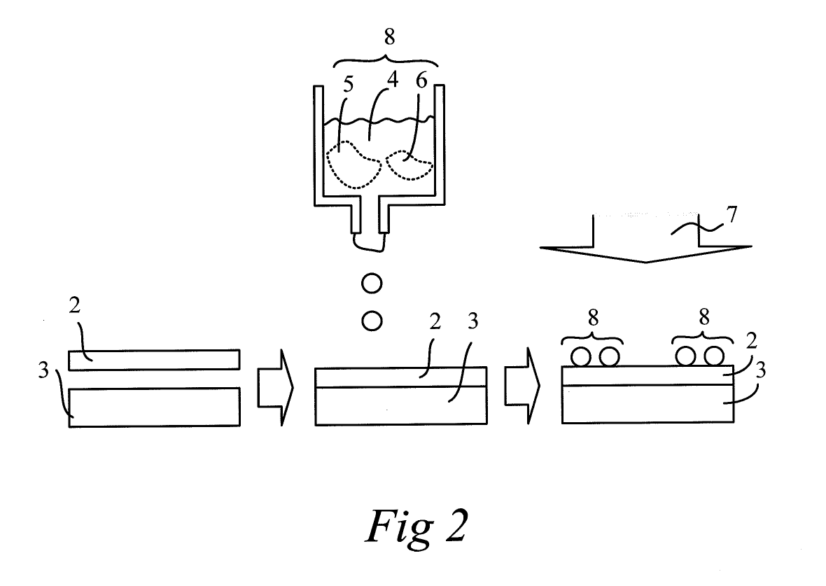

Please refer to FIGS. 2, 3 and 4, which schematically illustrate the method of the present invention. The method of the present invention comprises the following three steps:
(1) Coating titanium oxide 2 in the form of membrane, nanometer-sized particles or powder onto a substrate 3 to form a preliminary coating.
(2) Adding a reducing agent 5 and a dispersing agent 6 to a metallic precursor 4 to form a solution 8 and then applying a small amount of the solution 8 to the coating.
(3) Using ultraviolet radiation 7 on the substrate 3 to reduce the metallic precursor 4 to a metal 41 and thus form a composite coating on the preliminary coating.

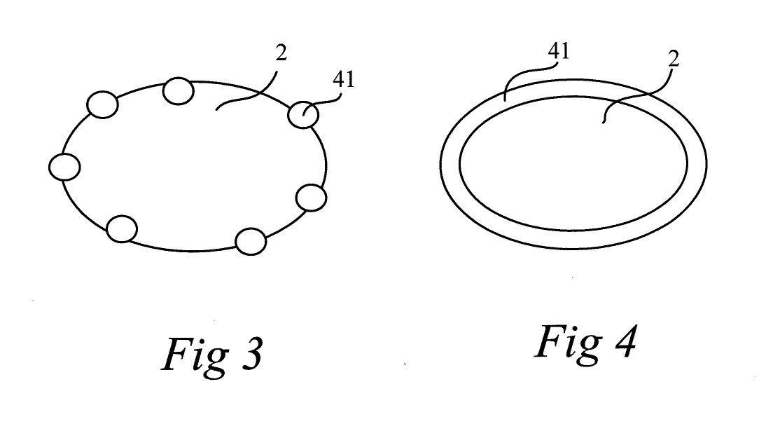

In the method of the present invention, a certain pattern of the composite coating may be accurately attained by controlling how the application device applies the solution on the preliminary coating. Regarding the structure of the composite coating, the metal 41 may be in the form of particles. These particles form small clusters or lumps scattered on top of the preliminary titanium oxide coating (as shown in FIG. 3). Alternatively, the metal 41 may be in the form of a membrane formed on top of the preliminary titanium oxide coating (as shown in FIG. 4). The form of particles or membrane is determined by whether the dispersing agent 6 is added in the process. The application of a small amount of the solution 8 to the coating may be done by piezoelectric printing, thermal bubble printing, minute drop titration method or other methods that can apply a fluid or a gas. The amount of solution may be in the range from 10 pico liter to 1 micro liter; more preferably, in the range from 100 pico liter to 1 micro liter; and even more preferably 50 pico liter. In addition, the goal of quantitative control may be attained by using only a certain small amount of the solution 8. The wavelength of the ultraviolet radiation 7 used in the process is in the range from 200 nm to 400 nm.

The solution 8 comprises at least the metallic precursor 4 and reducing agent 5. The addition of the dispersing agent 6 is determined by the type of intended result. The dispersing agent 6 may be water, ethanol (alcohol), ethylene glycol or other catalyst that can make the metal evenly spread out on top of the preliminary coating. The metallic precursor 4 may be hexachloroplatinic acid, gold tetrachloride, copper sulfate, silver nitrate or other compounds that may be reduced to a metal via photochemical reaction.

The final composite coating may be used as a conductive wire if it has a high content of metal. Because a certain pattern of the composite coating may be accurately attained as previously described, such composite coating may be used in the following applications to enhance performance. For example, such composite coating may be used as the electrodes in a proton exchange membrane fuel cell, used as the photocatalyst in sewage treatment or used for the electrodes in the dye-sensitized solar cell. Moreover, a plurality of the final composite coatings may be used as a capacitor.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

1. A method of applying a metallic precursor to a titanium oxide coating to form a composite coating or material, comprising the following steps:
coating titanium oxide in the form of a membrane, nanometer-sized particles or powder onto a substrate to form a preliminary coating;
adding a reducing agent and a dispersing agent to a metallic precursor to form a solution and then using an application device to apply a small amount of the solution to the preliminary coating; and
radiating ultraviolet radiation on the substrate to reduce the metallic precursor via photochemical reaction to a metal and hence forming a composite coating.

2. The method as recited in claim 1, further comprising the step of controlling how the application device applies the solution to the coating to accurately obtain a certain pattern of the composite coating.

3. The method as recited in claim 1, wherein, regarding the structure of the final composite coating, the method further comprises using particles as the metal, the particles forming small clusters scattered on top of the final composite coating.

4. The method as recited in claim 1, wherein, regarding the structure of the final compound coating, the method further comprises using a membrane as the metal placed on top of the membrane of titanium oxide.

5. The method as recited in claim 1, wherein in the step of adding, the small amount of the solution is applied to the preliminary coating by one of piezoelectric printing, thermal bubble printing, minute drop titration method and using a fluid or a gas method.

6. The method as recited in claim 1, wherein quantitative control is attained by using only a certain small amount of the solution.

7. The method as recited in claim 1, further repeating the method for a coating or a structure comprising a plurality of the final composite coatings.

8. The method as recited in claim 1, the comprising the step of using a wavelength of the ultraviolet radiation in the range from 200 nm to 400 nm.

9. The method as recited in claim 1, comprising the step of using a solution having at least the metallic precursor and reducing agent, and the addition of the dispersing agent is determined by intended result.

10. The method as recited in claim 9, comprising the step of using water, ethanol (alcohol) or ethylene glycol as the dispersing agent.

11. The method as recited in claim 9, comprising the step of using hexachloroplatinic acid, gold tetrachloride, copper sulfate or silver nitrate as the metallic precursor.

12. The method as recited in claim 9, comprising the step of using ethylene glycol as the reducing agent.

13. The method as recited in claim 1, comprising the step of using the final composite coating as an electrically conductive wire.

14. The method as in recited claim 1, comprising the step of using the final composite coating as electrodes in a proton exchange membrane fuel cell.

15. The method as recited in claim 1, comprising the step of using the final composite coating for electrodes in a dye-sensitized solar cell.

16. The method as recited in claim 1, comprising the step of using the final composite coating as a photocatalyst in sewage treatment.

17. The method as recited in claim 7, comprising the step of using a plurality of the final composite coatings as a capacitor.

18. The method as recited in claim 1, the range of a small amount of the solution is from 10 pico liter to 1 micro liter.
